(19) United States
(12) Patent Application Publication
(10) Pub. No.: US 2011/0197032 A1
(43) Pub. Date: Aug. 11, 2011

(54) CACHE COORDINATION BETWEEN DATA SOURCES AND DATA RECIPIENTS

(75) Inventor: Eric M. Patey, Rockport, MA (US)

(73) Assignee: Microsoft Corporation, Redmond, WA (US)

(21) Appl. No.: 12/701,847

(22) Filed: Feb. 8, 2010

(51) Int. Cl. G06F 12/08; G06F 15/16; G06F 15/173

(52) U.S. Cl. 711/133; 709/224; 707/620; 711/E12.026; 711/E12.025

(57) ABSTRACT

A data recipient configured to access a data source may exhibit improved performance by caching data items received from the data source. However, the cache may become stale unless the data recipient is informed of data source updates. Many subscription mechanisms are specialized for the particular data recipient and/or data source, which may cause an affinity of the data recipient for the data source, thereby reducing scalability of the data sources and/or data recipients. A cache synchronization service may accept requests from data recipients to subscribe to the data source, and may promote cache freshness by notifying subscribers when particular data items are updated at the data source. Upon detecting an update of the data source involving one or more data items, the cache synchronization service may request each subscriber of the data source to remove the stale cached representation of the updated data item(s) from its cache.

### BACKGROUND

Many computing scenarios involve a data source comprising one or more data items, such as a file server comprising a set of files or a database comprising a set of database objects, which may be accessed by one or more data recipients. The data recipients may contact the data source to read a current copy of various data items, and may also be permitted to request updates to the data items, including a creation, duplication, alteration, deletion, or relocation of the data item. Many of these scenarios involve a connection of a data recipient to the data source over a network, which may occasionally be slow, especially for frequent accesses of large data items. Therefore, it may be desirable for the data recipient to retain a cache comprising local copies of recently accessed data items, so that subsequent accesses to these data items may be fulfilled by providing the local representation of the data item instead of having to issue a redundant request to the data source and receipt of the data item over the network.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While the caching of data items stored in data sources may be desirable, complications may arise in some scenarios. As a first example, configuring some data recipients to access a particular data source may involve data-source-specific information, such as a network address or caching protocol utilized by the data source, or some details of the particular data source. As a second example, the data may be replicated over mirrored versions of a data source (e.g., a replicated set of databases offered by different database servers), but a data recipient may be configured with an affinity for a particular data source, and may be inflexible in utilizing the other data sources offering the same data. As a third example, if caching involves a configured connection between a particular data recipient and a particular data source, it may be difficult to scale up these replicated data sources offering redundant copies of the data and/or to include more data recipients. These complications may be particularly difficult to manage in scenarios that may be scaled to support many data sources and/or data recipients, such as a server farm scenario and a deployable computing environment involving a set of devices interoperating as a “mesh.”

Instead, a general-purpose data cache synchronization mechanism may be provided whereby data recipients may subscribe to receive cache updates of a data source. For example, a cache synchronization service may be configured to issue notifications of such updates so that subscribed data recipients may appropriately update local caches of the data source. For example, the cache synchronization service may accept subscription requests from data recipients and may maintain a subscriber list. When any data item in the data source is updated, the cache synchronization service may simply notify the data recipients that an update has occurred to the specified items, and the data recipients may discard any cached representations of such data items. A general-purpose subscription technique of this nature may increase the compatibility and reduce the complexity in subscribing a data recipient to any data source, and may therefore reduce affinity and promote scalability of bodies of data sources and data recipients.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a data recipient configured to provide data items from a data source.

FIG. 2 is an illustration of another exemplary scenario featuring a data recipient configured to provide data items from two data sources, where the data recipient has an affinity for a particular data source.

FIG. 3 is an illustration of an exemplary scenario featuring a cache synchronization service and a data recipient configured to provide data items from a data source in accordance with the techniques discussed herein.

FIG. 4 is a flow chart illustrating an exemplary method of configuring a cache synchronization service to coordinate a data source with a cache of one or more data recipients in accordance with the techniques discussed herein.

FIG. 5 is a flow chart illustrating an exemplary method of configuring a data recipient to access data items of a data source by subscribing to a cache synchronization service in accordance with the techniques discussed herein.

FIG. 6 is a component block diagram illustrating an exemplary cache synchronization service communicating with an exemplary data recipient, each implementing an exemplary system configured according to the techniques discussed herein.

FIG. 7 is an illustration of an exemplary computer-readable storage medium comprising processor-executable instructions configured to embody one or more of the provisions set forth herein.

FIG. 8 is an illustration of an exemplary scenario wherein the techniques presented herein may be advantageously utilized.

FIG. 9 is an illustration of an exemplary deployable computing environment (mesh) scenario wherein the techniques presented herein may be advantageously utilized.

FIG. 10 is an illustration of an exemplary cache synchronization service configured to notify subscribers of a changed data item involved in a data item update

FIG. 11 is an illustration of an exemplary cache synchronization service configured to notify subscribers of changed items upon a reconnection event following a disconnection event.

FIG. 12 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve a data recipient of a data source, such as a data-driven application coupled with a database server configured to provide database records, a file accessing client coupled with a file server configured to provide access to hosted files, and a web browser coupled with a webserver configured to render web pages. Such data recipients may receive requests (e.g., from users and/or applications that consume such data sources) for data items comprising the data source, and may negotiate access to such data items with the data source. In many such scenarios, it may be desirable for the data recipient to implement a cache, such that repeatedly requested data items may be stored by the data recipient for quicker access. As a first example, the data recipient communicates with the data source over a network, such as a wired or wireless local area network, a cellular network, or the internet, and frequent or redundant accesses to the network may be slow and/or bandwidth-intensive. As a second example, if the data recipient utilizes a particular data item on a frequent basis, such as many times a second, the data source and/or data recipient may be inefficiently burdened with repeatedly requesting, retrieving, sending, and receiving the data item, especially where the data item is updated infrequently or not at all.

In these and other scenarios, it may be advantageous for the data recipient to implement a cache where data items that have recently been received from the data source. For example, when the data recipient receives an access request (such as from a user or an application bound to a particular data source) for one or more data items, the data recipient may check the cache to see if a recent version of each data item is available. If so, the data recipient may return the cached representation of the data item; if not, the data recipient may request the data item from the data source, and upon receiving the data item, may store it in the cache. In this manner, a data recipient may reduce some inefficiencies caused by redundant requests to the data source for the data item, thereby yielding improved application performance and reduced consumption of computing resources such as bandwidth, memory, and processor utilization.

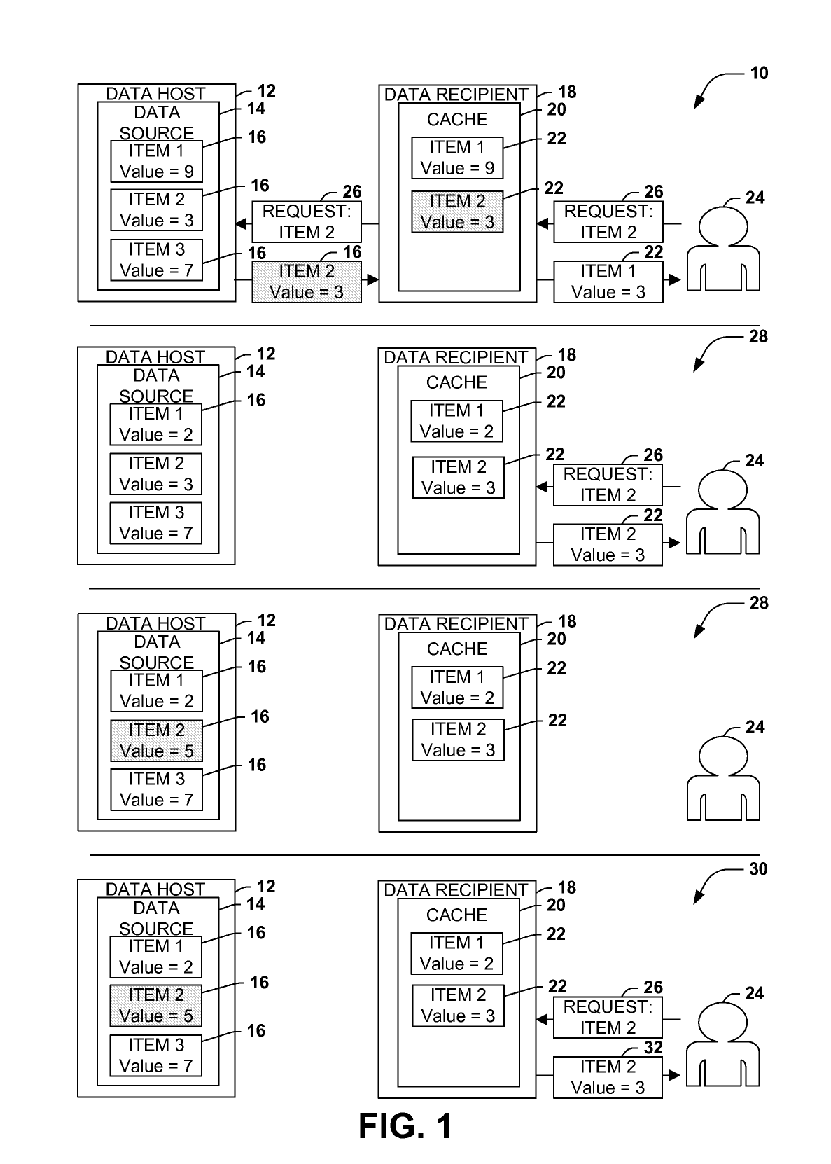

FIG. 1 presents a first exemplary scenario featuring a local caching of data items 16 of a data source 14 provided by a data host 12, such as a file server, a database server, or an object server. A data recipient 18 may be configured to contact the data source 14 through the data host 12 in order to access data items 16 from the data source 14 at the request of a user 24. In order to facilitate this accessing, the data recipient 18 may comprise a cache 20 having a cached representation 22 of data items 16 of the data source 14. For example, at a first time point 10, the data source 14 stored by the data host 12 may include three data items 16 having different values, and the data recipient 18 may store within the cache 20 a cached representation 24 of a first data item 16 having a numeric value of nine, which the data recipient 18 may have previously obtained from the data host 12 in response to a previous query and may have stored in the cache 20. When the user 24 issues an access request 26 for a second data item 16, the data recipient 18 may examine the cache 20 in search of a cached representation 22 of the second data item 16. Since no cached representation 22 of the second data item 16 exists, the data recipient 18 may contact the data source 14 (through the data host 12) to request the second data item 16, and upon receipt, may store a cached representation 22 of the second data item 16 in the cache 20, and may provide the second data item 16 to the user 24 in response to the first access request 26. At a second time point 28 when the user 24 submits a second access request 26 for the second data item 16, the data recipient 18 may again examine the cache 20 for a cached representation 22 of the second data item 16, and finding a cached representation 24 thereof, may provide the cached representation 22 to the user 24 in response to the second access request 26. Thus, the second access request 26 may be fulfilled without contacting the data source 14, thereby conserving the bandwidth and processing capacity of both the data host 12 and the data recipient 18 in requesting, retrieving, sending, and receiving a redundant copy of the second data item 16.

However, one potential problem with caching is the possibility that the data recipient 18 may utilize a cached representation 22 of a data item 16 after the corresponding data item 16 stored in the data source 14 (which may comprise the authoritative version of the data item 16) has been updated, thereby relying on a “stale” representation of the data item 16. For example, at a third time point 28 in FIG. 1, the data source 14 may receive an update that alters the value of the second data item 16 from three to five. However, the data recipient 18 is not aware of the update, and therefore continues to store in the cache 20 a stale cached representation 22 of the second data item 16. When, at a fourth time point 30, the user 24 issues a third access request 26 for the second data item 16, a stale cached representation 32 of the second data item 16 is provided to the user 24 having the value of three, which is incorrect, since the authoritative version of the second data item 16 (stored by the data source 14) specifies the value five for the second data item 16. In this manner, cache “staleness” may inhibit the accurate, up-to-date representation of the data source 14.

In order to reduce cache staleness, techniques may be used to coordinate the cache 20 of the data recipient 18 with the data source 14. As a first technique, upon receiving an access request 26 for a data item 16 and before providing a cached representation 22 of the data item 16, the data recipient 18 may check with the data source 14 to verify that the cached representation 22 is current, e.g., by sending a hashcode of the cached representation 22 for comparison with a hashcode of the data item 16 in the data source 14, or by comparing a version number or last update time of the cached representation 22 with the version number or last update time of the data item 16. This technique may avoid a redundant delivery of the data item 16 if it has not been updated, which may be useful if the data item 16 is comparatively large; however, bandwidth and processing capacity of the data source(s) 14 and data recipient(s) 18 are still consumed with this verification, and the network transport of the verification still delays a response to the access request 26 for the data item 16.

As a second technique, the data recipient 18 may actively maintain the currency of the cached representation of the data item 16 by periodically polling the data source 14 for updates to the data item 16. If the data item 16 has been updated, the data recipient 18 may request the data item 16 and may store the updated data item 16 in the cache 20 as an updated cached representation 22. While this technique may promote the freshness of the cache 20, this technique may unnecessarily consume significant bandwidth and processor capacity, particularly if the data item 16 is not updated often or if many data items 16 are cached. Moreover, it may be inefficient to request a series of updates to a data item 16 that is not accessed between updates; and, conversely, the data recipient 18 cannot guarantee the freshness of the cached representation 22 of a data item 16 between instances of polling.

As a third technique, the data source 14 may notify the data recipient 18 upon receiving updates to the data source 14 that alter one or more data items 16. For example, a data source 14 and data recipient 18 may have a particular relationship, such as an active and sustained network connection or an agreement established through a specialized protocol, whereby the data source 14 may notify the data recipient 18 of updates that may affect the freshness of the cache 20 of the data recipient 18. In this manner, the data source 14 and data recipient 18 may coordinate to reduce cache staleness while also promoting efficient use of the cache 20. However, if this specialized relationship is particular to the data source 14 and/or the data recipient 18, it may be difficult to scale to more complex scenarios.

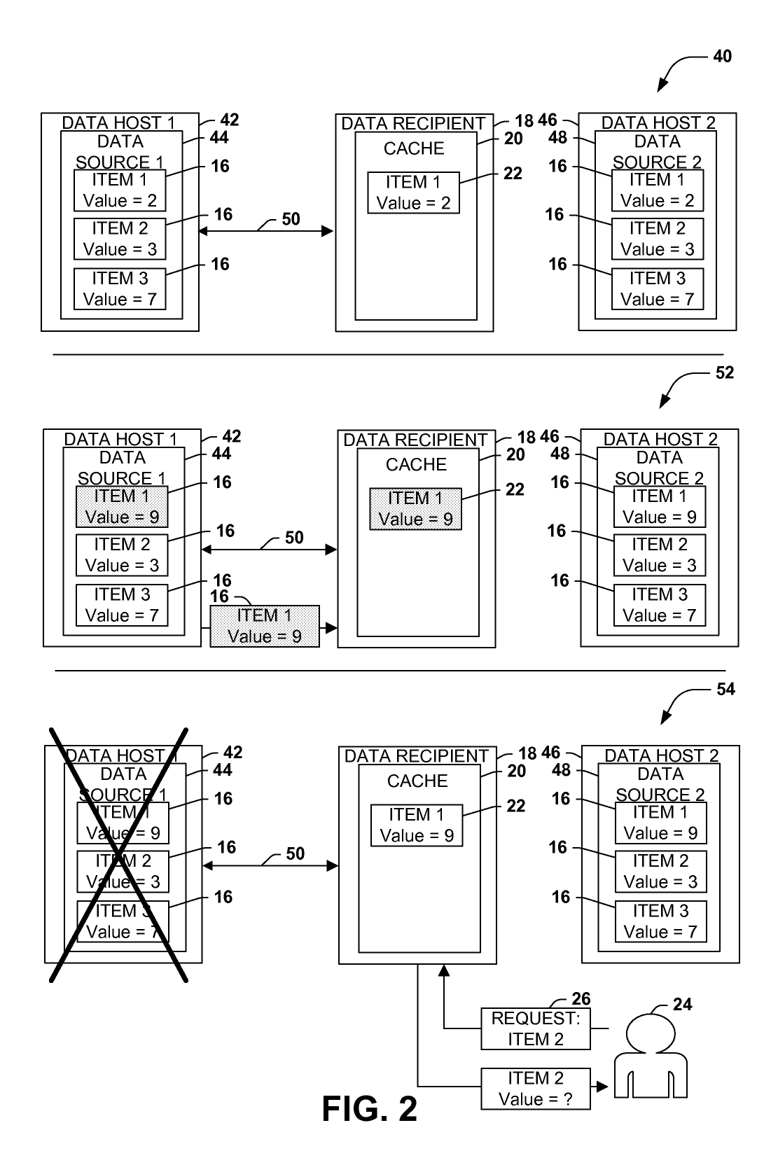

FIG. 2 presents an exemplary scenario featuring a data recipient 18 that is configured to access a first data source 44 stored by a first data host 42, and a second data source 48 stored by a second data host 46. In this exemplary scenario, the first data source 44 and the second data source 48 comprise redundant data sets, such as two mirror copies of a database hosted by different data hosts 12 and exposed to one or more data recipients 18, e.g., for improved reliability (in case one data host crashes or becomes corrupted or unreachable) and/or performance (for concurrently handling several access requests 26 for data items 16 of the data source 14.) Additionally, the data recipient 18 comprises a cache 20 that comprises a cached representation 22 of a first data item 16, which may, e.g., have been received from the first data source 44 in response to an access request 26 for the first data item 16 that was previously received by the data recipient 18. This cache 20 may be included, e.g., in order to improve performance further and/or to reduce the use of network or computational resources consumed by redundant requests for data items 16.

At a first time point 40 of FIG. 2, the data recipient 18 may initiate a specialized relationship 50 with the first data source 44, whereby the data recipient 18 is configured to receive notifications of updates to the data source 14 stored by the first data source 44. At a second time point 52, when the first data source 44 detects an update to the data source 14 that involves an update to the first data item 16, the first data source 44 may honor this specialized relationship 50 by sending the first data item 16 to the data recipient 18, which may then update the cached representation 22 of the first data item 16. Consequently, if a user 24 were to request the first data item 16 from the data recipient 18, the data recipient 18 may be able to provide a fresh version of the first data item 16 without having to contact the first data source 44 or the second data source 48.

However, specialized relationships 50 of the type illustrated in FIG. 2 may be problematic. For example, the data recipient 18 might be configured to establish the specialized relationship 50 specifically with the first data source 44, e.g., according to information specific to the first data host 42 (such as its network address or identity) or a configuration of the first data source 44 (such as a particular version of a database system utilized by the first data source 44.) The data recipient 18 may therefore become overly reliant on the first data source 44 for maintaining the freshness of the cache 20, thus establishing an “affinity” for the first data source 44. If, as further illustrated in FIG. 2, at a third time point 54, the first data source 44 were to become unavailable to the data recipient 18 (e.g., due to a crash or corruption of the first data host 42, or a network partition that disrupted communication between the first data host 42 and the data recipient 18), the data recipient 18 may be unable to receive updates from the first data source 44, and therefore may be unable to maintain the freshness of cached representations 22 of data items 16. At this third time point 54, it may be difficult for the data recipient 18 to overcome its affinity for the first data source 44 in order to utilize the second data source 48. For example, the data recipient 18 might not be aware of the second data source 48, or might not be able to establish the same specialized relationship 50 with the second data source 48, e.g., if the second data source 48 uses a different version of database software than the first data source 44. It may also be difficult and/or frustrating to reconfigure the data recipient 18 to rely on the second data source 48; e.g., the data recipient 18 may be hard-coded to utilize the network address of the first data host 42. Therefore, at this third time point 30, when a user 24 requests a second data item 16 that is stored in the data source 14 but is not yet stored in the cache 20 as a cached representation 22, the data recipient 18 may not be properly configured to access the second data source 48 in order to request and retrieve the second data item 16. As illustrated in this example, affinity of a data recipient 18 for the first data source 44 might cause the data recipient 18 to fail to retrieve the requested data item 16 from the second data source 48, thereby diminishing the advantage of the server mirroring. Affinity might also cause other problems or disadvantages, e.g., overreliance on a particular data source 14 that results in a computational load imbalance and/or an overuse of bandwidth of one data source 14 as compared with another data source 14.

In view of these complexities, alternative techniques may be developed to promote the coordination and freshness of data source caching, while reducing the affinity of a data recipient 18 to a particular data source 14. In these alternative techniques, respective data recipients 18 may be configured to maintain a cache 20 comprising cached representations 22 of data items 16 received from one or more data sources 14, and may fulfill access requests 26 for such data items 16 using the cached representations 22 thereof, if available in the cache 20. In order to promote the freshness of the caches 20 of the respective data recipients 18, a cache synchronization service may be configured to maintain a subscriber list, comprising a set of references to data recipients 18 that have subscribed to the data source 14. Each data recipient 18 may send to the cache synchronization service a subscription request to subscribe to updates to one or more data sources 14 for which the data recipient 18 maintains a local cache. When a data recipient 18 wishes to update the data source 14, it may notify the cache synchronization service, which may in turn notify the data recipients 18 by sending to the data recipients 18 a removal request to remove the updated data item(s) 16 from any cache 20 that is maintained by the data recipients 18. Upon receiving from the cache synchronization service a removal request to remove a cached representation 22 of a data item 16 from the cache 20, the data recipient 18 may remove the cached representation 22 from the cache 20.

In this manner, a cache synchronization service and data recipient 18 may coordinate to maintain the freshness of the cache 20 in an efficient manner. Moreover, a comparatively simple, general-purpose subscription mechanism may permit a cache synchronization service to coordinate caches with a potentially large set of data recipients 18 in a scalable way. For example, a data recipient 18 may be able to subscribe to data sources 14 of different types and configurations, while reducing the amount of reconfiguration or data-source-specific configuration. Similarly, a cache synchronization service may coordinate the caches 20 of data recipients 18 of different types and configurations, and in the absence of specialized knowledge about any particular data recipient 18. These techniques therefore promote compatibility and scalability while reducing affinity in server-client data caching scenarios.

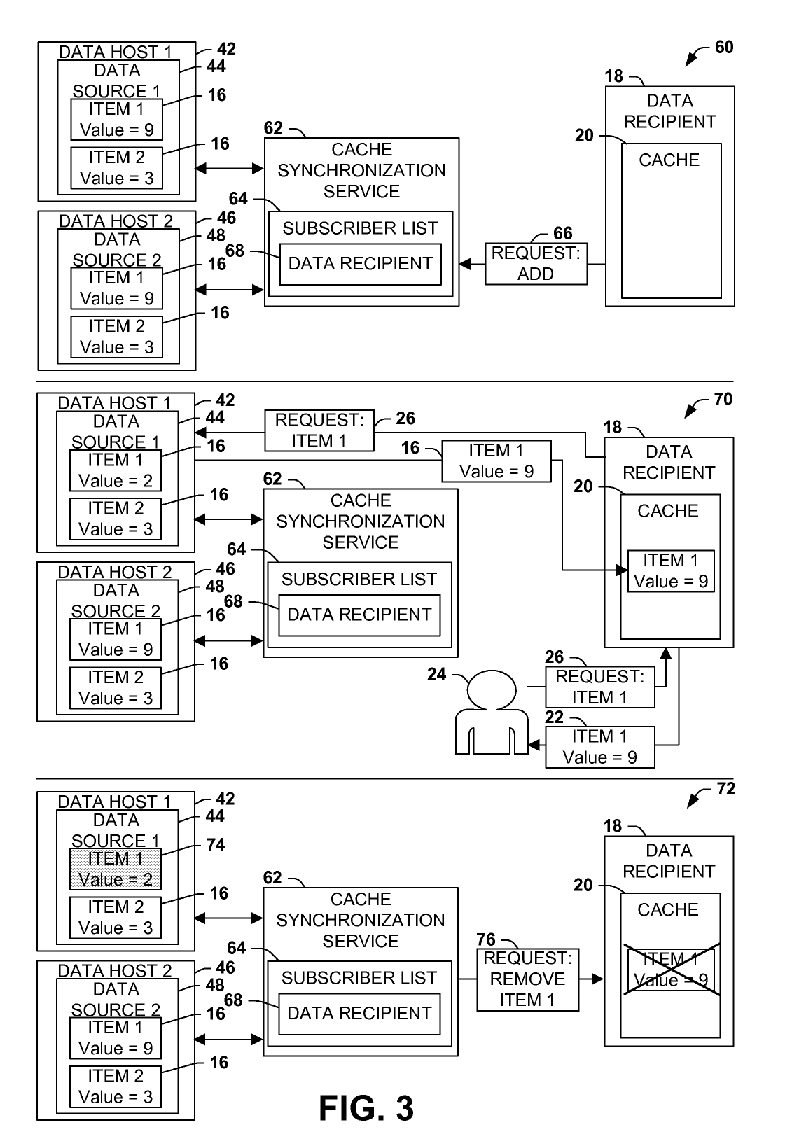

FIG. 3 presents an exemplary scenario featuring a data recipient 18 communicating with a first data host 42 hosting a first data source 44 and a second data host 46 hosting a second data source 46. The data recipient 18 may have a cache 20 for promoting quick and efficient access to the data items 16 of the data source 14. Within this exemplary scenario, a cache synchronization service 62 may be provided to promote the freshness of the cached representations 22 of data items 16 stored in the caches 20 of one or more data recipients 18. For example, the cache synchronization service 62 may generate a subscriber list 64, comprising a set of subscribers 68 to the data source 14 of the respective data host 12. The cache synchronization service 62 may also communicate with the first data source 44 and the second data source 48 to detect updates to the data items 16 of the data sources, and that notifies the data recipient 18 of such updates, so that the data recipient 18 may evict from the cache 20 any stale cached representations 22 of the data item 16.

For example, at a first time point 60 of FIG. 3, the data recipient 18 may send to the cache synchronization service 62 a subscription request 66 to subscribe to the first data source 44 and/or the second data source 48. The cache synchronization service 62 may receive the subscription request 66, and may add the data recipient 18 to the subscriber list 64 as a subscriber 68 of the first data source 44 and/or the second data source 48. At a second time point 70, a user 24 may send to the data recipient 18 an access request 26 for a data item 16 of the data source 14, such as a first data item 16. The data recipient 18 may search the cache 20 for a cached representation 22 of the first data item 16, and failing to locate such a cached representation 22, may request the first data item 16 from either the first data source 44 or the second data source 48. Upon receiving the first data item 16, the data recipient 18 may store in the cache 20 a cached representation 22 of the first data item 16, and may provide the first data item 16 to the user 24. The data recipient 18 may then fulfill subsequent access requests 26 for the first data item 16 by providing the cached representation 22, until the third time point 72, when the data item 16 is updated. At this third time point 72, the cache synchronization service 62 may detect an update of the first data source 44 and/or the second data source 48 that involves the first data item 16. The cache synchronization service 62 may then consult the subscriber list 64, and for each subscriber 68 (including the data recipient 18), may send a removal request 76 to remove the first data item 16 from the cache 20. The data recipient 18, upon receiving the removal request 76, may remove the cached representation 22 of the first data item 16 from the cache 20. If, subsequent to the third time point 72, the data recipient 18 receives an access request 26 for the first data item 16, the data recipient 18 may again search the cache 20, fail to identify a cached representation 22 of the first data item 16, request the first data item 16 from the first data source 44 and/or the second data source 48, and upon receipt, may store in the cache 20 a refreshed cached representation 22 of the data item 16 (in addition to fulfilling the access request 26 by providing the refreshed cached representation 22 of the data item 16.) In this manner, the data recipient 18 may provide data items 16 in an efficient manner using the cache 20, while also coordinating with the data sources 14 to maintain the freshness of the cached representations 22 of the data items 16 of the data source 14.

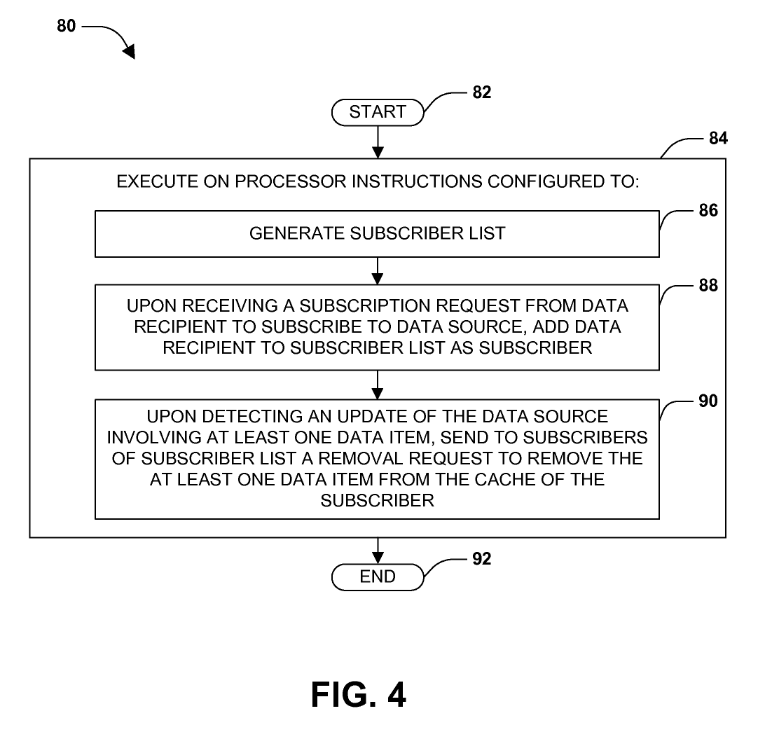

FIG. 4 presents a first exemplary embodiment of these techniques, illustrates as an exemplary method 80 of configuring a cache synchronization service 62 to coordinate a data source 14 comprising at least one data item 16 with at least one data recipient 18 having a cache 20. The exemplary method 80 may be implemented, e.g., as software instructions stored in memory and configured to execute this exemplary method 80 on a processor of the cache synchronization service 62. The exemplary method 80 begins at 82 and involves executing 84 on the processor instructions configured to perform the techniques discussed herein. In particular, the instructions may be configured to generate 86 a subscriber list 64 comprising subscribers 68 of the data source 14, and to, upon receiving a subscription request 66 from a data recipient 18 to subscribe to the data source 14, add 88 the data recipient 18 to the subscriber list 64 as a subscriber 68. The instructions may also be configured to, upon detecting an update of the data source 14 involving at least one data item 16, send 90 to the subscribers 68 of the subscriber list 64 a removal request 76 to remove the at least one data item 16 from the cache 20 of the subscriber 68. In this manner, the exemplary method 80 may configure the cache synchronization service 62 to coordinate with the data recipient 18 to promote the freshness of cached representations 22 of the data items 16 of the data source 14, and so the exemplary method 80 ends at 92.

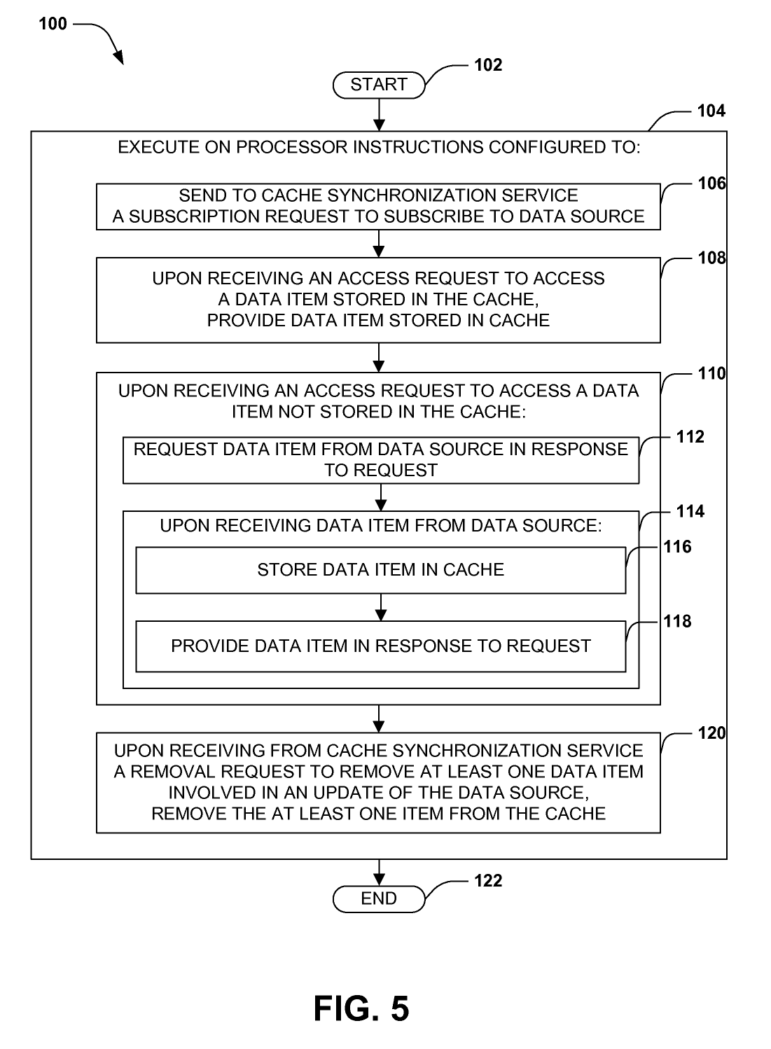

FIG. 5 presents a second exemplary embodiment of these techniques, illustrated as an exemplary method 100 of configuring a data recipient 18 having a cache 20 and a processor to provide data items 16 of a data source 14. The exemplary method 100 may be implemented, e.g., as software instructions stored in memory and configured to execute this exemplary method 100 on a processor of the data recipient 18. The exemplary method 100 begins at 102 and involves executing 104 on the processor instructions configured to perform the techniques discussed herein. In particular, the instructions may be configured to send 106 to a cache synchronization service 62 a subscription request 66 to subscribe to the data source 14. The instructions may also be configured to, upon receiving an access request 26 to access a data item 16 stored in the cache 20 (e.g., as a cached representation 24 of the data item 16), provide 108 the data item 18 stored in the cache 20 in response to the access request 26. The instructions may also be configured to, upon receiving 110 an access request 26 to access a data item 16 not stored in the cache 20, request 112 the data item 16 from the data source 14, and upon receiving 114 the data item 16 from the data source 14, store 116 the data item 16 in the cache 20 (e.g., as a cached representation 22 thereof), and provide 118 the data item 16 in response to the access request 26. Finally, the instructions may be configured to, upon receiving from the cache subscription service 62 a removal request 76 to remove from the cache 20 at least one data item 16 involved in an updating of the data source 14, remove 120 the at least one data item 16 (e.g., a cached representation 22 thereof) from the cache 20. In this manner, the exemplary method 100 may configure the data recipient 18 to fulfill access requests 26 for the data items 16 of the data source 14 with improved efficiency (via caching) and improved freshness (via the subscription to the data source 14 and the removal of stale cached representations 22), and so ends at 122.

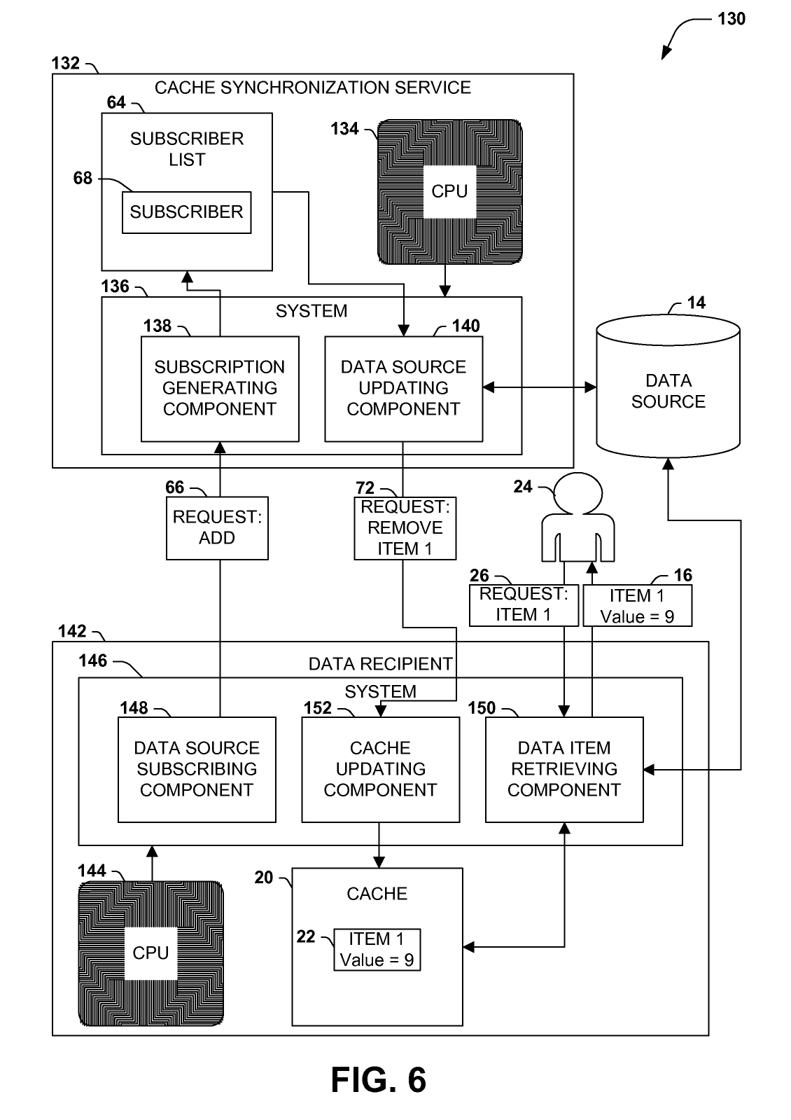

FIG. 6 presents additional embodiments of these techniques, illustrated as operating within an exemplary scenario 130 featuring a cache synchronization service 132 having access to a data source 14 comprising a set of data items 16 and a data recipient 142 configured to fulfill access requests 26 for the data items 16 on behalf of one or more users 24. The cache synchronization service 132 may comprise a processor 134, and the data recipient 142 may also comprise a processor 144 (of the same type as the processor 134 of the cache synchronization service 132 or of a different type), which each device may use, e.g., to execute instructions comprising an embodiment of these techniques embedded therein. As a third exemplary embodiment of these techniques, the cache synchronization service 132 may comprise an exemplary system 136 configured to coordinate the data source 14 with various data recipients 18 (including the data recipient 142 illustrated in this exemplary scenario 130) respectively having a cache 20. The exemplary system 136 of the cache synchronization service 132 may comprise a subscription generating component 140 that may be configured to generate a subscriber list 64 comprising subscribers 68 of the data source 14, and to, upon receiving a subscription request 66 from a data recipient 18 (including this data recipient 142) to subscribe to the data source 14, add the data recipient 18 to the subscriber list 64 as a subscriber 68. The exemplary system 136 of the cache synchronization service 132 may also comprise a data source monitoring component 140 that may be configured to, upon updating the data source 14 involving at least one data item 16, send to the subscribers 68 of the subscriber list 64 a removal request 76 to remove the at least one data item 16 (including cached representations 22 thereof) from the caches 20 of the respective subscribers 68.

FIG. 6 also illustrates, as a fourth exemplary embodiment of these techniques, an exemplary system 146 operating within the data recipient 142 (e.g., implemented as a set of instructions executed by the processor 134 of the data recipient), and configured to provide data items 16 of a data source 14 by communicating with a cache synchronization system (such as the cache synchronization service 132 illustrated in FIG. 6.) The exemplary system 146 comprises a data source subscribing component 148 that is configured to send to the cache synchronization service 132 a subscription request 66 to subscribe to the data source 14. The exemplary system 146 also comprises a data item retrieving component 150 that is configured to, upon receiving an access request 26 to access a data item 16 stored in the cache 20 (e.g., as a cached representation 22 of the requested data item 16), provide the data item 16 stored in the cache 20; and to, upon receiving an access request 26 to access a data item 16 not stored in the cache 20, request the data item 18 from the data source 14 and, upon receiving the data item 16 from the data source 14, store the data item 16 in the cache 20 (e.g., as a cached representation 22 thereof) and provide the data item 16 in response to the access request 26. The exemplary system 146 also comprises a cache updating component 152 that may be configured to, upon receiving from the cache synchronization service 132 a removal request 76 to remove from the cache 20 at least one data item 16 involved in an updating of the data source 14, remove the at least one data item 16 (e.g., any cached representation 22 thereof) from the cache 20. In this manner, the exemplary system 142 may fulfill requests for the data items 16 of the data source in an efficient manner (via caching) and with improved freshness (via the updating of the cache 20 by subscribing to the data source 14 to receive notifications of updates to the data source 14.)

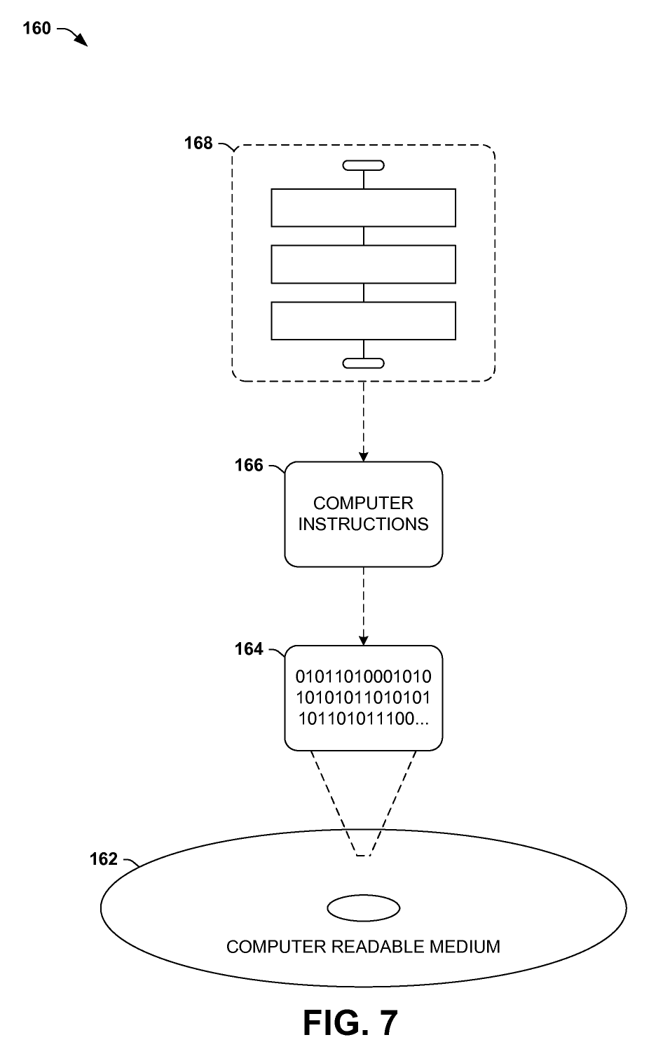

Still another embodiment involves a computer-readable storage medium comprising processor-executable instructions configured to apply the techniques presented herein. An exemplary computer-readable storage medium that may be devised in these ways is illustrated in FIG. 7, wherein the implementation 160 comprises a computer-readable storage medium 162 (e.g., a CD-R, DVD-R, or a platter of a hard disk drive), on which is encoded computer-readable data 164. This computer-readable data 164 in turn comprises a set of computer instructions 166 configured to operate according to the principles set forth herein. In one such embodiment, the processor-executable instructions 166 may be configured to perform a method of configuring a cache synchronization service 62 to coordinate a data source 14 with 20 caches of one or more data recipients 18, such as the exemplary method 80 of FIG. 4. In another such embodiment, the processor-executable instructions 166 may be configured to implement a method of configuring a data recipient 18 to provide data items 16 of a data source 14 by utilizing a cache synchronization service 62 to maintain the freshness of the cache 20, such as the exemplary system 100 of FIG. 5. Some embodiments of this computer-readable medium may comprise a nontransitory computer-readable storage medium (e.g., a hard disk drive, an optical disc, or a flash memory device) that is configured to store processor-executable instructions configured in this manner. Many such computer-readable storage media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 80 of FIG. 4 and the exemplary method 100 of FIG. 5) to confer individual and/or synergistic advantages upon such embodiments.

A first aspect that may vary among embodiments of these techniques relates to the scenarios wherein these techniques may be advantageously utilized. As a first example of this first aspect, many types of data sources 14 comprising various types of data items 16 may be utilized, including a database comprising database tables and records, a filesystem comprising a set of files, and a website comprising a set of web pages. As a second example of this first aspect, may types of data recipients 18 may be devised to consume such data sources 14, including a data-driven application bound to a database client, a filesystem browser configured to access the fileserver over a network, and a web browser configured to view web pages hosted by a webserver. As a third example of this first aspect, the data recipients 18 may feature many types of caches 20 utilizing many caching strategies, such as a first-in-first-out (FIFO) strategy resembling a queue, a last-in-first-out (LIFO) strategy resembling a stack, and a priority- or ranking-based strategy, which may be sensitive to relative priorities of data items 16 in the cache 20 (e.g., some data items 16 may be more frequently used or more sensitive to freshness than others, and so may be more advantageously retained in the cache 20 over other data items 16.) As a fourth example of this first aspect, these techniques may be implemented in various architectural configurations within a cache synchronization service 62 and/or data recipient 142, e.g., as an application programming interface (API) layer through which access requests 26 for data items 16 may be submitted by users 24 and/or data-driven applications, or as an interface to the data source 14 serviced by the cache synchronization service 62.

As a fifth example of this first aspect, many types of architectures may utilize these techniques. As a first variation of this fifth example, the exemplary scenario 130 of FIG. 6 illustrates the use of these techniques to coordinate a cache 20 of a single data recipient 142 with a data source 14 operably coupled with a single cache synchronization service 62. For example, the cache synchronization service 132 might operate on the same device as the data recipient 142, e.g., as an application programming interface (API) configured to interface one or more data-driven applications with the data source 14 while maintaining the freshness of a shared cache 20 of the data source 14. Alternatively, more complex scenarios may utilize these techniques to even greater advantage, due to the improved ease of configuration and scalability.

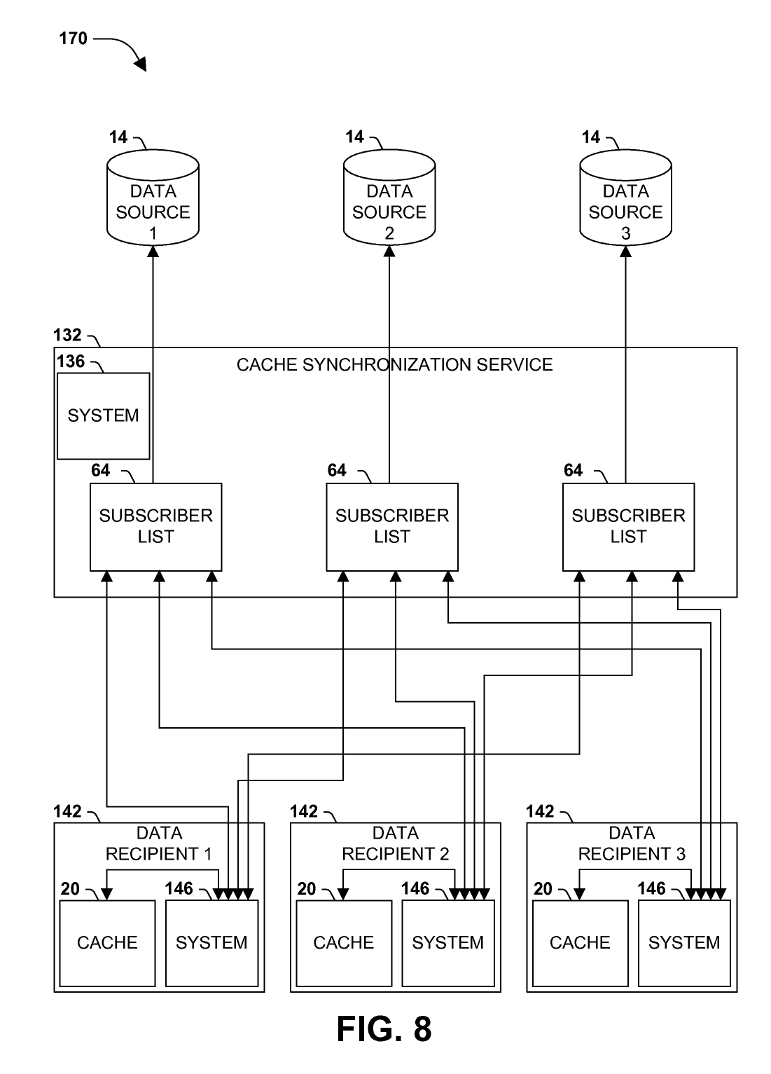

FIG. 8 illustrates a second exemplary scenario 170 wherein these techniques may be utilized, wherein a cache synchronization service 132 may coordinate with several data sources 14 to manage corresponding caches 20 on various data recipients 18. The data sources 14 may comprise mirrored versions of the same data set, different portions of the same data set distributed across several machines, and/or may different data sets comprising unrelated sets of data items 16. In this exemplary scenario 170, the cache synchronization service 132 may promote the freshness of the caches 20 of the data recipients 18 by including an embodiment of these techniques (e.g., the exemplary system 136 illustrated in FIG. 6) that accepts subscription requests from the data recipients 18 to subscribe to one or more of the several data sources 18 serviced by the cache synchronization service 132, that detects updates to the data sources 18 involving at least one data item 16, and that notifies subscribers 68 upon receiving such updates. Additionally, the cache synchronization service 132 might generate and maintain a set of subscriber lists 64, each comprising the set of subscribers 68 to a particular data source 18. In this manner, whenever a data item 16 is updated in any data source 14, the cache synchronization service 132 may notify the data recipients 142 by sending a removal request 76 to remove the stale cached representation(s) 22 of the updated data item(s) 16 from the respective caches 20 of the data recipients 142.

In still other scenarios, it may be advantageous to configure one or more computers as both a data host 12 of a data source 14 and as a data recipient 18, whereby the computer may provide access to its data source 14 to other computers, but may also include a cache 20 comprising cached representations 22 of various data items 16 hosted by the other computers, and may therefore subscribe to the other computers as a data recipient 18. As a third exemplary scenario, a peer-to-peer network may utilize these techniques to coordinate the synchronization of data items 16 of one or more data sources 14 among a set of peers, using a cache synchronization service 62 to maintain its cache 20 of data sources 14 hosted by other devices.

A more particular example of a peer-to-peer network wherein computers may serve as both data host 12 and data recipient 18 according to these techniques involves a deployable computing environment. Recent attempts have been made to develop techniques for providing access to a computing environment among an array of devices in a consistent, deployable, and extensible manner. These techniques also seek to provide automated synchronization of data objects among all such devices, and the deployment of a common set of applications among the cooperating devices, and a centralized service for managing the procuring, installing, using, and uninstalling of applications among such devices. The set of data objects and applications is not necessarily identical among various devices; e.g., a workstation may contain a full copy of the data set and a large number of high-performance applications (e.g., photo editing software and graphically intensive games), while a cellphone device (having a smaller data store) may store only a subset of the data objects, and may feature portability applications (e.g., a GPS-based mapping software) that are not relevant to a non-portable workstation. However, many applications and data objects related thereto may be shared among such devices (e.g., a calendar application configured to manage a user calendar object), and the computing environment may be adapted to enable the distribution and synchronization of the application and data objects among such devices. It may therefore be appreciated that a computer system may be advantageously represented in a manner that enables the deployment of the computing environment among a set of devices.

In one such technique, the computing environment—including a set of applications, the application resources, and data objects used thereby, collectively comprising a shared data source 14—is represented in a manner that may be delivered to devices for rendering according to the capabilities of the device. The objects include the data objects of the computer system, such as the user files and data created by the user, as well as representations of the myriad devices comprising the computing environment of the user. A computing environment represented in this manner may be delivered to any device and rendered in a manner suitable for the capabilities of the device. For instance, a workstation may render the information as a robust and general-purpose computing environment, while a public workstation may render a different computing environment experience through a web browser (e.g., as a virtual machine that may be discarded at the end of the user's session), and a cellphone may provide a leaner interface with quicker access to cellphone-related information (e.g., contacts, calendar, and navigation data.) Moreover, updates to the information set (e.g., preference changes and updates to data files contained therein) may be applied to the authoritative source of the information set, and thereby propagated to all other devices to which the information set is delivered.

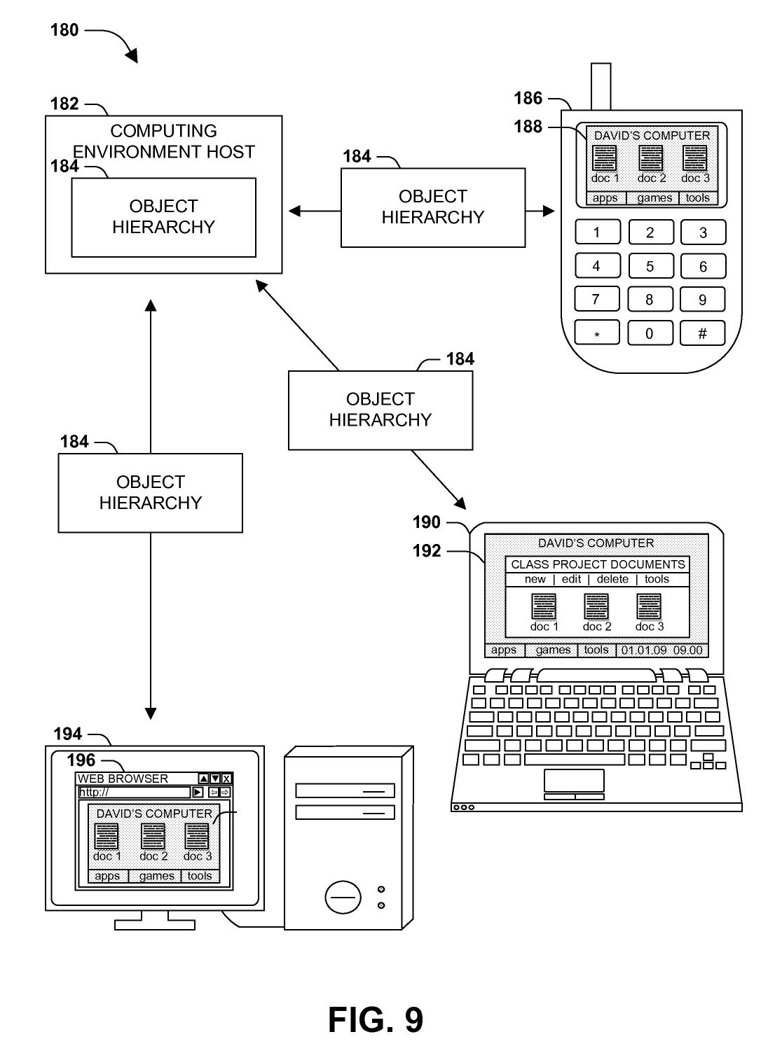

FIG. 9 illustrates one such scenario 180, wherein the computing environment may be hosted by a computing environment host 182, which may store and manage an object hierarchy 184. The computing environment host 182 may also render the object hierarchy 184 in different ways on behalf of various devices, such as a cellphone device 186, a personal notebook computer 190, and a public workstation 194, and also on behalf of different types of users having different access privileges. Updates to the computing environment may be propagated back to the computing environment host 182, and may be automatically synchronized with other devices. Hence, the computing environment may therefore be devised and presented as a cloud computing architecture, comprising a device-independent representation (a “cloud”) expressed as a consistent rendering across all devices (“clients”) that form a mesh of cooperating portals (with device-specific properties) to the same computing environment.

With respect to this exemplary scenario, the deployable computing environment may represent the plurality of devices as data hosts 62 of a portion of the data source 14 and/or data recipients 142, and at least one data item 16 of the data source 14 may be represented within the deployable computing environment. For example, a device sharing the object hierarchy 184 may accept subscription requests 66 from other devices in the mesh to subscribe to updates to the data source 14 stored by the device (representing the portion of the object hierarchy 184 that is stored on the device), and/or may submit subscription requests 66 to other devices in the mesh to subscribe to updates of data items 16 hosted by such other devices. In this manner, the mesh may coordinate the sharing of data objects comprising the object hierarchy 184 with improved efficiency (due to the avoidance of polling), with reduced staleness of data objects (due to the prompt notification of subscribers 68), and/or with improved scalability (due to the ease with which new devices may be added to the mesh synchronization based on the widely compatible subscription mechanism.) For example, a first device may operate as a data host 12 of a first data source 14 of at least one data item 16 represented in the deployable computing environment, and may provide access to such data items 16 to other devices; and may also operate as a data recipient of a second data source 14 hosted by another device and comprising at least one other data item 16 represented in the deployable computing environment, and may request access to such data items 16 on behalf of users 24 and/or applications. The device may therefore implement a cache 20 of the data items 16 of the second data sources 14 hosted by another device. In order to maintain the freshness of the cache 20, the device may subscribe to a cache subscription service 62 (such as the computing environment host 182), and may receive from the cache subscription service 62 notifications of data item updates from other devices. Those of ordinary skill in the art may devise many scenarios wherein the techniques discussed herein may be advantageously utilized.

A second aspect that may vary among embodiments of these techniques relates to the type of publish/subscribe (“pub/sub”) protocol utilized by the cache synchronization service 62 and the data recipients 18 in order to permit the notification by the cache synchronization service 62 of the data recipients 18 of updates to the data source 14. It may be appreciated that, while the publication and subscription system is presented herein in a comparatively simple manner (e.g., as a subscriber list 64 containing one or more subscribers 68, to which the data recipients 18 may request inclusion through the sending of a subscription request 66), many publish/subscribe protocols may be implemented in this capacity, including the D-Bus interprocess bus and PubSubHubbub. Additionally, different publish/subscribe protocols may present various advantages and disadvantages as compared with other publish/subscribe protocols, and a particular scenario may be more compatible with one publish/subscribe protocol than another publish/subscribe protocol. Those of ordinary skill in the art may consider, select, and implement many such publish/subscribe protocols in conjunction with an embodiment of the techniques discussed herein.

A third aspect that may vary among embodiments of these techniques relates to the manner of configuring the cache synchronization service 62 to detect one or more updates to the data source 14 and the data items 16 altered therein in order to send a removal request 76 to subscribers 68. As a first example, the cache synchronization service 62 may poll the data source 14 to identify updates to the data source 14 involving at least one data item 16 (e.g., by evaluating a Really Simple Syndication (RSS) feed published by the data source 14 in order to identify recent updates, and the data items 16 involved therein.) As a second example of this third aspect, the data source 14 may be configured to notify the cache synchronization service 62 upon receiving an update, and the cache synchronization service 62 may therefore detect the update simply by receiving from the data source 14 a notification of an update involving at least one data item 16.

As a third example of this third aspect, the data recipients 18 may be configured to notify the cache synchronization service 62 of updates to the data source 14. For example, in the exemplary scenario 170 of FIG. 8, the cache synchronization service 62 may be configured to accept updates to the data source 14 requested by a data recipient 142, such as by receiving from a data recipient 142 a data item update involving one or more data items 16. In such scenarios, an embodiment may be configured to send the data item update to the data source 14 in order to update the at least one data item 16 on behalf of the data recipient 142. The cache synchronization service 62 may then notify all subscribers 68 of the update to the data source 14 involving the at least one data item 16. Moreover, if the data recipient 142 that sent the update is a subscriber 68, the embodiment may be configured to send the removal request 76 to remove cached representations 22 of the one or more data items 16 to all subscribers 68 except the subscriber 68 that sent the data item update (since this subscriber 68 may already be informed of the updating of the data items 16.) In a similar embodiment, the cache synchronization service 62 may receive the update from a data recipient having a data recipient identifier, such as a distinctive or identifying name or network address. The cache synchronization service 62 may include the data recipient identifier with the removal request 76 to remove the at least one data item 16 (including cached representations 22 thereof) from the cache 20 of the subscriber 68. Each subscriber 68 may compare this data recipient identifier with its own identifier, and may endeavor to determine if the removal request 76 was initiated by a data item update that it requested; if so, the subscriber 68 may be configured to disregard the removal request 76. These and other techniques may improve the efficient use of bandwidth and processing capacity of the data hosts 62 and/or data recipients 142 while coordinating the refreshing of the caches 20. Those of ordinary skill in the art may devise many ways of configuring the cache synchronization service 62 to detect updates to the data source 14 while implementing the techniques discussed herein.

A fourth aspect that may vary among embodiments of these techniques relates to the manner of configuring the cache synchronization service 62 to send removal requests 76 to subscribers 68 for the removal of stale cached representations 22 of data items 16. Some embodiments may be configured, e.g., to reduce the sending of redundant removal requests 76. As a first example of this second aspect, one or more data items 16 may be frequently updated (e.g., more frequently updated than requested 26 by a user 24 or application.) A modest amount of staleness of cached representations 22 of such data items 16 may be tolerable, and may be desirable over frequent removal requests 76 to remove the cached representations 22. An embodiment of these techniques included in a cache synchronization service 62 may endeavor to limit a series of removal requests 76 for removing such frequently updated or infrequently requested data items 16 from the caches 20 of subscribers 68, such as by sending such removal requests 76 only periodically, or only after several updates to the data item 16 or after a non-trivial update to the data item 16 have been received. For example, the access frequency of accesses of respective data items 16 may be monitored, and a data item update specifying an updated data item may be sent to the subscribers 68 upon determining that the access frequency of accesses of the data item 16 is above an access frequency threshold, upon determining an update count (e.g., a number of updates received since sending the last notification) of the data item 16 exceeding an update count threshold, or upon receiving a non-trivial update of the data item 16 (e.g., notification may be reserved only for item updates that are regarded as non-trivial or significant and that warrant notification of the data recipient 142.)

As a second example of this fourth aspect, an embodiment of these techniques included in the cache synchronization service 62 may track which data recipients 142 might currently store a cached representation 22 of a particular data item 16, and may endeavor to limit the sending of removal requests 76 for removing stale cached representations 22 after an update to the data item 16. For example, upon sending a data item 16 to a subscriber 68, the embodiment may associate the subscriber 68 with the data item 16. Subsequently, when an update to the data source 14 affects the data item 16 and the cache subscription service 62 prepares to send to the subscribers 68 of the subscriber list 64 a removal request 76 to remove the stale cached representation 22 of the data item 16, the embodiment may send the removal request 76 only to subscribers 68 that are associated with the data item 16. Moreover, because the removal request 76 results in a de-caching of the data item 16, the embodiment may disassociate the subscriber 68 from the data item 16 (until the data item 16 is again provided to the subscriber 68 in response to a subsequent access request 26 to access the data item 16.)

As a third example of this fourth aspect, instead of requesting from subscribers 68 only the removal of the stale cached representation 22 of an updated data item 16, the request may also include a replacement of the stale cached representation 22 with a current cache representation 22. For example, the removal request 76 may include a data item update that may be utilized to refresh the cached representation 22. This variation may be helpful, e.g., for reducing the inefficiency of follow-up requests for the updated version of the data item 16 from the data source 14, which may be likely to arrive from the subscribers 68 in response to the removal request 76, and which may arrive in a large and concurrent volume that may exhaust the data source 14. The item update may comprise, e.g., a differential comparison of the current data item 16 with the stale cached representation 22 thereof, and/or instructions for modifying the stale cached representation 22 to generate the refreshed version (such as a patch.) This variation may be advantageous, e.g., where the data item 16 is large and where the degree of change is comparatively small, such that sending the entire data item 16 may be inefficient, or where the data item 16 is difficult to represent in isolation (e.g., a heavily interrelated data item 16 with many references to other data items 16 that may have to be remapped.) However, this variation may be inapplicable, e.g., where the version of the cached representation 22 of the data item 16 stored by a subscriber 68 is unknown, or where different subscribers 68 have different cached representations 22 that may involve generating many data item updates. As a second variation, the removal request 76 may include a complete representation of the data item 16 with which subscribers 68 may replace the stale cached representation 22. This example may be advantageous, e.g., where the data item 16 is small enough to send efficiently, or where different subscribers 68 may have different cached representations 22 of the data item 16. Additionally, an embodiment may utilize a mixture of these techniques, such as by sending data item updates comprising a complete representation of some data items 16 (such as small data items 16), by sending data item updates comprising a differential comparison or patch for updating other data items 16 (such as large data items 16 that have only been slightly changed), and by sending only the removal request 76 to remove the cached representation 22 for still other data items 16 (such as data items 16 that are infrequently requested and therefore inefficient to update until such an access request 26 is received, or that are more frequently updated than requested, such that an update to the cached representation 22 may not be used before a subsequent update.) Those of ordinary skill in the art may devise many ways of configuring an embodiment included in a cache synchronization service 62 of issuing requests to remove data items 22 from the caches 20 of subscribers 68 while implementing the techniques discussed herein.

A fifth aspect that may vary among embodiments of these techniques relates to the manner of configuring a data recipient 142 to handle removal requests 76 to update the data item 18 that may be received from the cache synchronization service 62. As a first example of this fifth aspect, a data recipient 142 may initiate a data item update of at least one data item 18, e.g., by receiving from a user of a data-driven application executing on the data recipient 142 an update of a data item 18 of the data source 14. The data recipient 142 may therefore send the data item update to the data source 18, and may notify the cache synchronization service 62 of the data item update. Moreover, the data recipient 142 may identify a cached representation 22 of an updated data item as having been stored in the cache 20 of the data recipient 142, where such cached representation 22 is stale due to the data item update. The data recipient 142 may proactively improve the freshness of the cache 20 (even before receiving a notification from the cache synchronization service 62 of the data item update) by removing the cached representation 22 from the cache 20.

As a second example of this fifth aspect, where a removal request 76 received from a cache synchronization service 62 includes a data item update, an embodiment included in a data recipient 142 may be configured to apply the data item update to the cache 20 in order to update and refresh at least one cached representation 22 of at least one data item 16. As a third example of this fifth aspect, where the data recipient 142 receives an access request (e.g., from a user 24 or an application) to update at least one data item stored in the cache 20, an embodiment included in the data recipient 142 may perform the updating by sending to the cache synchronization service 62 a data item update of the data item 16. The embodiment may also proactively remove the cached representation 22 of the data items 16 from the cache, so that, upon receiving a subsequent request for the data item 16, the data recipient 142 retrieves a refreshed representation from the cache synchronization service 62. Alternatively, if the data item update cannot fail to be accepted by the cache synchronization service 62, the data recipient may proactively update the cached representation 22 of the data item 16 in the cache 20. As a fourth example of this fifth aspect, an embodiment included in a data recipient 142 may evaluate removal requests 76 by the cache synchronization service 62 to remove the cached representation 22 of the data item 16 from the cache 20 by comparing a data recipient identifier specified within any such data item update to the identifier of the data recipient 142, and by disregarding any removal request 76 where the data recipient identifier matches the identifier of the data recipient 142. Those of ordinary skill in the art may devise many ways of configuring an embodiment included with a data recipient 142 to handle removal requests 76 to remove cached representations 24 of various data items 16 from the cache 20 of the data recipient 142 while implementing the techniques discussed herein.

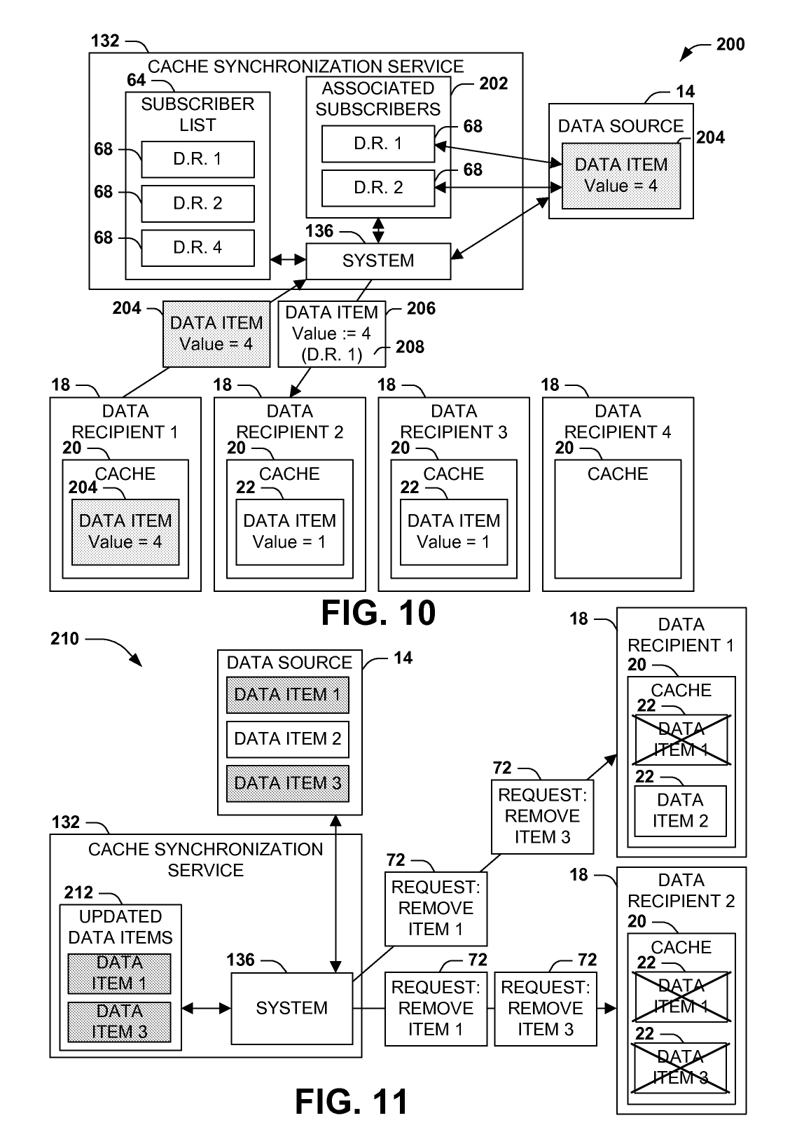

FIG. 10 illustrates an exemplary scenario 200 featuring several of the variations of these second and third aspects. In this exemplary scenario 200, the cache synchronization service 132 is operably coupled with a data source 14 comprising a data item 22 with an initial value of one, which may be accessed by a set of data recipients 18, each having a cache 20. A data item update 204, such as a request to change the value of the object to four, may be received from a first data recipient 18 and applied to the data source 14 to update the data item 16. While the cache synchronization service 132 might simply send a data item update 206 to all data recipients 18, an embodiment of these techniques (such as the exemplary system 136 of FIG. 6) that is implemented by the cache synchronization service 132 may more efficiently notify the data recipients 18. As a first example, the exemplary system 136 may generate a subscriber list 64 that identifies data recipients 18 that have requested to be included as subscribers 68 of the data source 14. In this exemplary scenario 200, the third data recipient 18 may not be listed as a subscriber 68 (e.g., the third data recipient 18 may be unreachable over the network, may have terminated the cache 20, or may have switched to an “offline mode,” where a stale cached representation 22 of the data item 16 is acceptable), and the cache synchronization service 132 may avoid sending a data update to the third data recipient 18.

In addition to this advantage, this exemplary scenario 200 includes several additional examples of improvements to the efficiency of the updating of cached representations 22 of data items 18. As a first exemplary advantage, the exemplary system 136 may identify the subscribers 68 that are associated with the data source 14, such as by maintaining an associated subscribers list 202 of each subscriber 68 that has requested the data item 22 since achieving connectivity with the cache synchronization service 62, and since having received a removal request 76 to remove the cached representation 22 of the data item 16 from its cache. In this exemplary scenario 200, the associated subscribers list 202 references the first data recipient 18 and the second data recipient 142, but not the fourth data recipient 18, which does not include a cached representation 22 of the data item 16 in its cache 20; therefore, the exemplary system 136 may avoid sending an unused removal request 76 to the fourth data recipient.

As a second advantage illustrated in the exemplary scenario 200 of FIG. 10, the first data recipient 18 may proactively update its cached representation 22 of the data item 16 (operating under a presumption that the item update 204 sent to the cache synchronization service 62 cannot fail to be accepted and applied to the authoritative version of the data item 16.) Because notifying the data recipient 18 that issued the item update 204 may be redundant, the exemplary system 136 may identify that the item update 204 was received from the first data recipient 18, and may avoid sending the first data recipient 18 (as a subscriber) a data item update 206, since the first data recipient 18 may have proactively updated the cached representation 22 of the data item 16. (Alternatively, because the item update 204 sent to subscribers 68 includes a data recipient identifier 208 of the data recipient that requested the update of the data item 16, the cache synchronization service 132 might have been configured to send the item update 204 to the first data recipient 18, which may have compared the data recipient identifier 208 with its own identifier, determined that the item update 204 corresponds to its request to update the data item 16, and disregarded the item update 204.)

As a third advantage illustrated in the exemplary scenario 200 of FIG. 10, an item update 206 that is sent to the second data recipient 18 may include instructions for refreshing the cached representation 22 instead of simply removing it from the cache 20, thereby avoiding the second data recipient 18 having to request from the data source 14, receive, and store in the cache 20 the current version of the data item 16. The second data recipient 18 may be configured to receive the item update 206, and to apply the item update 206 to the cache 20 in order to update the cached representation 22 of the data item 16, thereby refreshing the cached representation 22 instead of simply removing it. In this manner, the exemplary system 136 may more efficiently handle the refreshing of the cached representations 22 of the data item 16 than by simply sending a removal request 76 to all data recipients 18, or even only to subscribers 68, to remove the cached representation 22 of the data item 16 from respective caches 20.

A sixth aspect that may vary among embodiments of these techniques (including embodiments executed on a cache synchronization service 132 and embodiments executed on a data recipient 142) relates to the manner of configuring such embodiments to handle network partition events, such as initially joining a network, detecting a network disconnection, and detecting a network reconnection. Such network partition events may occur, e.g., whenever a particular cache synchronization service 62 and data recipient 142 transition from a disconnected state to a connected state or vice versa, because network disruption may result in a loss of synchrony of a data item 16 in the data source 14 of the cache synchronization service 62 with the corresponding cached representation 22 of the data item 16 in a cache 20 of the data recipient 142. As a first example of this sixth aspect, an embodiment included in a data recipient 142 may be configured to send subscription requests 66 to subscribe to the cache synchronization service 62 to receive updates regarding one or more data sources 14 upon establishing a network connection. Alternatively, the embodiment may be configured to defer subscription to the cache synchronization service 62 until an access request 26 for a data item 16 of the data source 14 is received.

As a second example of this sixth aspect, when an embodiment included in a data recipient 142 detects a network connection to the cache synchronization service 62 (including a network reconnection to such cache synchronization service 62 following a network disconnection therefrom), the embodiment may empty the cache 20 for the data source 14, and may send to the cache synchronization service 62 a subscription request 66 to (re)subscribe to the data source 14. In this manner, the embodiment may configure the data recipient 142 to repopulate its cache 20 of the data source 14 with freshly cached representations 22 by storing data items 16 received from the cache synchronization service 62 in response to subsequent request.

Embodiments included in a cache synchronization service 132 may also be configured to promote the freshness of caches 20 following a disconnection from one or subscribers. As a third example of this sixth aspect, upon detecting a reconnection to at least one subscriber 68 of a data source 14 after detecting a disconnection from the subscriber 68, an embodiment included in a cache synchronization service 132 may send to the subscriber 68 a request to empty its cache 20 of the data source 14. This example may be advantageous, e.g., where many or significant updates to data items 16 of the data source 14 have occurred during the disconnection, and/or where the degree of asynchrony of the data source 14 and the cache 20 of the subscriber 68 cannot be determined. However, in some scenarios, such updates may be few or easily determined, and it may be more efficient for the embodiment to endeavor to notify one or more reconnected subscribers 68 of updates during the period of disconnection. For example, upon detecting a disconnection from at least one subscriber 68, an embodiment within a cache synchronization service 132 may generate a data item update list comprising an updated data items list comprising data items of a subscribed data source 14 that have been updated during the period of disconnection. During this period of disconnection, the cache synchronization service 62 may, upon detecting an update of one or more data items 16 of the data source 14, add the data item 16 to the data item update list. Finally, upon detecting a reconnection to the previously disconnected subscribers 68, the embodiment within the cache synchronization service 132 may send the data item update list to the subscribers 68, e.g., as a removal request to remove cached representations 22 of any data items 16 that were updated during the period of disconnection.

FIG. 11 presents an exemplary scenario 210 illustrating this fourth example of the sixth aspect, where a cache synchronization service 132 includes an embodiment of these techniques (such as the exemplary system 136 of FIG. 6) operably coupled with a data source 14 to which two data recipients 18 are subscribed. Upon detecting a disconnection from the data recipients 18, the exemplary system 136 may generate an updated data items list 212, and may detect updates to particular data items 16 of the data source 14 (such as a first data item 16 and a second data item 16) during the period of disconnection. Such updates may be initiated, e.g., by the cache synchronization service 132 or a user 24 thereof, or from other data recipients 18 that remain connected to the cache synchronization service 62. When the cache synchronization service 132 detects a reconnection to the data recipients 18, the exemplary system 136 within the cache synchronization service 132 may send the updated data items list 212 to the data recipients 18, e.g., as a series of removal requests 76 to remove the respective data items 16 included in the updated data items list 212. The data recipients 18 may receive such removal requests 76 and may remove such cached representations 22 in the respective caches 20 of the data recipients 18, thereby promoting the freshness of the caches 20. Those of ordinary skill in the art may devise many ways of configuring embodiments included with cache synchronization services 132 and/or data recipients 142 of handling network partitioning events while implementing the techniques discussed herein.

A seventh aspect that may vary among embodiments of these techniques relates to additional features may be implemented by one or more embodiments operating within a cache synchronization service 132 and/or a data recipient 142 in relation to a data source 14, and that embodiments of these techniques may comply with, invoke, and/or facilitate. As a first example of this seventh aspect, in a multi-server environment (such as the server farm scenario illustrated in FIG. 8 and the mesh scenario illustrated in FIG. 9), it may be difficult for cache synchronization services 132 and data recipients 142 to identify data items 16 in a non-ambiguous manner, particularly where some data items 16 are redundantly stored in two or more data sources 14. It may be advantageous to develop and utilize a naming scheme for such data sources 14 and/or data items 16 that unambiguously identifies a referenced object, and such names may be utilized in associated cached representations 22 of a data item 16 with the authoritative version thereof, and in removal requests 76 to remove and/or update identified data items 16.

As a second example of this seventh aspect, one or more data sources 14 may exhibit more sophisticated features, such as the capacity of a data recipient 142 to lock one or more data items 14 (e.g., in a transactional system), and a concurrency control scheme for resolving conflicting updates of a data item 16 by various data recipients 142. Embodiments of these techniques may utilize such features, e.g., by updating a cached representation 22 of a data item 16 stored in the cache 20 of a subscriber 68 only after determining the success or failure of a data item update as per the concurrency control system. Those of ordinary skill in the art may devise many techniques for configuring embodiments to comply with, invoke, and/or facilitate the features of various data sources while implementing the techniques discussed herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable nontransitory device, carrier, or media. Of course, those skilled in the art will recognize many modifications may be made to this configuration without departing from the scope or spirit of the claimed subject matter.

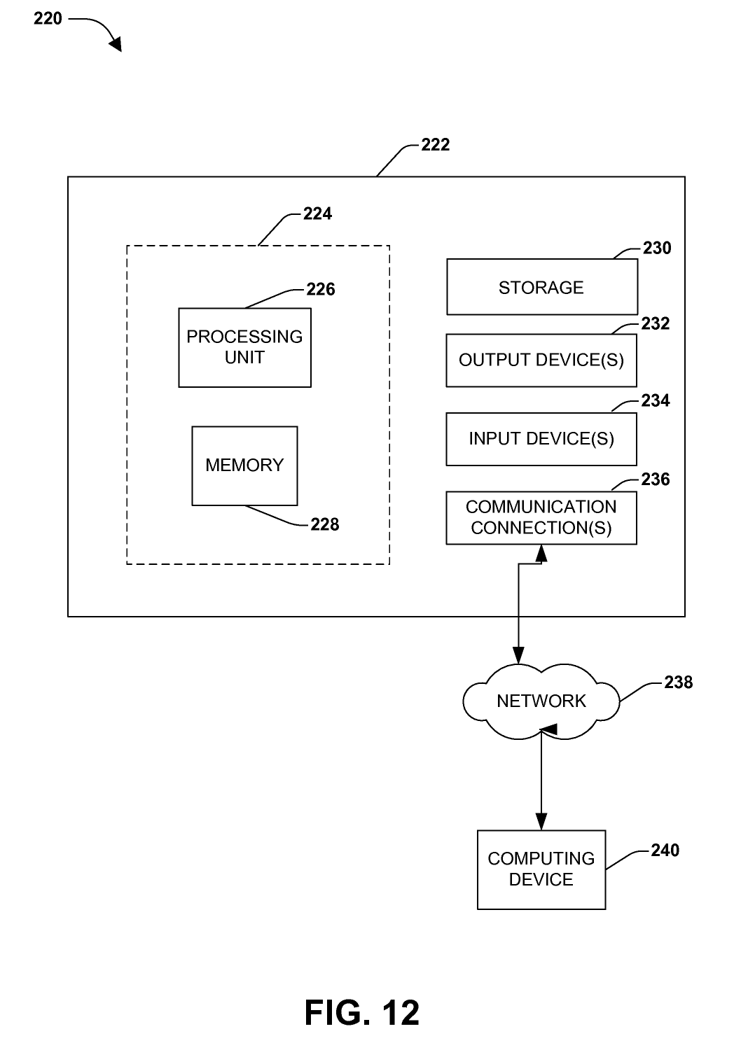

FIG. 12 and the following discussion provide a brief, general description of a suitable computing environment to implement embodiments of one or more of the provisions set forth herein. The operating environment of FIG. 12 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 12 illustrates an example of a system 220 comprising a computing device 222 configured to implement one or more embodiments provided herein. In one configuration, computing device 222 includes at least one processing unit 226 and memory 228. Depending on the exact configuration and type of computing device, memory 228 may be volatile (such as RAM, for example), non-volatile (such as ROM, flash memory, etc., for example) or some combination of the two. This configuration is illustrated in FIG. 12 by dashed line 224.

In other embodiments, device 222 may include additional features and/or functionality. For example, device 222 may also include additional storage (e.g., removable and/or non-removable) including, but not limited to, magnetic storage, optical storage, and the like. Such additional storage is illustrated in FIG. 12 by storage 230. In one embodiment, computer readable instructions to implement one or more embodiments provided herein may be in storage 230. Storage 230 may also store other computer readable instructions to implement an operating system, an application program, and the like. Computer readable instructions may be loaded in memory 228 for execution by processing unit 226, for example.

The term “computer readable media” as used herein includes computer storage media. Computer storage media includes volatile and nonvolatile, removable and non-removable media implemented in any method or technology for storage of information such as computer readable instructions or other data. Memory 228 and storage 230 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 222. Any such computer storage media may be part of device 222.

Device 222 may also include communication connection(s) 236 that allows device 222 to communicate with other devices. Communication connection(s) 236 may include, but is not limited to, a modem, a Network Interface Card (NIC), an integrated network interface, a radio frequency transmitter/receiver, an infrared port, a USB connection, or other interfaces for connecting computing device 222 to other computing devices. Communication connection(s) 236 may include a wired connection or a wireless connection. Communication connection(s) 236 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 222 may include input device(s) 234 such as keyboard, mouse, pen, voice input device, touch input device, infrared cameras, video input devices, and/or any other input device. Output device(s) 232 such as one or more displays, speakers, printers, and/or any other output device may also be included in device 222. Input device(s) 234 and output device(s) 232 may be connected to device 222 via a wired connection, wireless connection, or any combination thereof. In one embodiment, an input device or an output device from another computing device may be used as input device(s) 234 or output device(s) 232 for computing device 222.

Components of computing device 222 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 222 may be interconnected by a network. For example, memory 228 may be comprised of multiple physical memory units located in different physical locations interconnected by a network.

Those skilled in the art will realize that storage devices utilized to store computer readable instructions may be distributed across a network. For example, a computing device 240 accessible via network 238 may store computer readable instructions to implement one or more embodiments provided herein. Computing device 222 may access computing device 240 and download a part or all of the computer readable instructions for execution. Alternatively, computing device 222 may download pieces of the computer readable instructions, as needed, or some instructions may be executed at computing device 222 and some at computing device 240.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of configuring a cache synchronization service to coordinate a data source comprising at least one data item with at least one data recipient having a cache, the method comprising:
executing on the processor instructions configured to:
generate a subscriber list comprising subscribers of the data source;
upon receiving a subscription request from a data recipient to subscribe to the data source, add the data recipient to the subscriber list as a subscriber; and
upon detecting an update of the data source involving at least one data item, send to the subscribers of the subscriber list a removal request to remove the at least one data item from the cache of the subscriber.

2. The method of claim 1:
the device represented within a deployable computing environment comprising a second device; and
at least one data item of the data source represented within the deployable computing environment.

3. The method of claim 1:
the instructions configured to, upon sending a data item to a subscriber, associate the subscriber with the data item; and
sending to the subscribers of the subscriber list a removal request to remove the at least one data item comprising:
for respective subscribers associated with the at least one data item:
send to the subscriber the request to remove the at least one data item from the cache of the subscriber; and
disassociate the subscriber from the data item.

4. The method of claim 1:
the data item updated in response to a data item update received from a data recipient, and
the instructions configured to apply the item update to the data source to update the at least one data item.

5. The method of claim 4:
the data recipient sending the item update comprising a subscriber of the data source, and
sending the request to the subscribers comprising: sending the request to the subscribers except the subscriber that sent the data item update.

6. The method of claim 1:
the data item updated in response to a data item update received from a data recipient having a data recipient identifier; and
sending the request to the subscribers comprising: sending to the subscribers of the subscriber list the data recipient identifier with the request to remove the at least one data item from the cache of the subscriber.

7. The method of claim 1, the instructions configured to, upon detecting the update of the data source involving the at least one data item, send to the subscribers a data item update of the at least one data item.

8. The method of claim 7, sending the item update comprising: sending the item update to the subscribers upon determining an access frequency of accesses of the data item above an access frequency threshold.

9. The method of claim 7, sending the item update comprising: sending the item update to the subscribers upon determining an update count of updates of the data item above an update count threshold.

10. The method of claim 7, sending the item update comprising: sending the item update to the subscribers upon receiving a non-trivial item update of the data item.

11. The method of claim 1, the instructions configured to, upon detecting a reconnection to at least one subscriber after detecting a disconnection from the at least one subscriber, send to the at least one subscriber a request to empty the cache of the data source.

12. The method of claim 1, the instructions configured to:
upon detecting a disconnection from at least one subscriber:
generate a data item update list comprising data items of the data source that are updated during the disconnection, and
upon detecting an updating of the data source involving at least one data item during the disconnection, add the data item to the data item update list; and
upon detecting a reconnection to the at least one subscriber, send the data item update list to the at least one subscriber.

13. A method of configuring a data recipient having a cache and a processor to provide data items of a data source using a cache synchronization service, the method comprising:
executing on the processor instructions configured to:
send to the cache synchronization service a subscription request to subscribe to the data source;
upon receiving an access request to access a data item stored in the cache, provide the data item stored in the cache;
upon receiving an access request to access a data item not stored in the cache:
request the data item from the data source, and
upon receiving the data item from the data source:
store the data item in the cache, and
provide the data item in response to the request; and
upon receiving from the cache synchronization service a removal request to remove from the cache at least one data item involved in an update of the data source, remove the at least one data item from the cache.

14. The method of claim 13:
the device represented within a deployable computing environment comprising a second device; and
at least one data item of the data source represented within the deployable computing environment.

15. The method of claim 13:
the request from the cache synchronization service comprising a data item update involving at least one data item; and
the instructions configured to, for respective data items involved in the data item update, applying the item update to the cache to update the at least one data item.

16. The method of claim 13, the instructions configured to, upon receiving a request to update at least one data item:
send a data item update to the cache synchronization service, and
upon identifying the data item stored in the cache, remove the data item from the cache.

17. The method of claim 16, removing the data item from the cache comprising: applying the item update to the cache to update at least one data item.

18. The method of claim 13:
the request to remove at least one data item comprising a data recipient identifier that identifies a data recipient of the update; and
removing the at least one data item from the cache comprising:
comparing the data recipient identifier of the request to an identifier of the device; and
upon determining that the data recipient identifier does not match the identifier of the device, removing the at least one data item from the cache.

19. The method of claim 12, comprising: upon detecting a connection to a cache synchronization service:
empty the cache of the data source, and
send to the cache synchronization service a subscription request to subscribe to the data source.

20. A computer-readable storage medium comprising processor-executable instructions that, when executed by a processor of a device represented in a deployable computing environment and connected with at least one second device represented in the deployable computing environment, the respective devices having a cache and storing a first data source comprising at least one data item of the deployable computing environment, coordinate the caches of the devices with the data sources of other devices by:
generating a subscriber list comprising subscribers of the first data source;
upon receiving a subscription request from a data recipient to subscribe to the first data source, adding the data recipient to the subscriber list as a subscriber;
upon sending a data item to a subscriber, associating the subscriber with the data item;
upon receiving from another device a data item update of a data item of the first data source, applying the item update to the data source to update the at least one data item;
upon detecting an update of the first data source involving at least one data item:
sending to the subscribers of the subscriber list a removal request to remove the at least one data item from the cache of the subscriber, the request including a data recipient identifier of a data recipient initiating the update, and
disassociating the subscriber from the data item;
upon detecting a disconnection from at least one subscriber of the first data source:
generating a data item update list comprising data items of the first data source that are updated during the disconnection, and
upon detecting an update of the data source involving at least one data item during the disconnection, add the data item to the data item update list;
upon detecting a reconnection to the at least one subscriber, send the data item update list of the first data source to the at least one subscriber;
send to another device represented in the deployable computing environment, operating as a cache synchronization service of a second data source, a subscription request to subscribe to the second data source;
upon receiving an access request to access a data item of the second data source that is stored in the cache, provide the data item stored in the cache;
upon receiving an access request to access a data item of the second data source that is not stored in the cache:
request the data item from the data source, and
upon receiving the data item from the data source:
store the data item in the cache, and
provide the data item in response to the request;
upon receiving from a cache synchronization service a removal request to remove from the cache at least one data item involved in an update of the second data source, the request comprising a data item update involving at least one data item, apply the item update to the cache to update the at least one data item; and
upon receiving a request to update at least one data item of the second data source that is stored in the cache:
send a data item update to at least one cache synchronization service of the data source comprising the at least one data item, and
remove the data item from the cache.
